(19) United States
(12) Patent Application Publication
(10) Pub. No.: US 2005/0080639 A1
(43) Pub. Date: Apr. 14, 2005

(54) Hardware sizing technique using benchmarks

(75) Inventor: Nan Danny Tang, Mountain View, CA (US)

Correspondence Address: INTERNATIONAL BUSINESS MACHINES CORP;IP LAW, 555 BAILEY AVENUE , J46/G4, SAN JOSE, CA, 95141, US

(73) Assignee: International Business Machines Corporation, Armonk, NY (US)

(21) Appl. No.: 10/682,619

(22) Filed: Oct. 8, 2003

(51) Int. Cl. G06F 17/60

(52) U.S. Cl. 705/1

(57) ABSTRACT

A method, apparatus and article of manufacture, implementing the method, of sizing hardware for software. An event arrival rate is determined. At least one processor system that has a benchmarked event processing rate greater than or equal to the event arrival rate is selected.

### BACKGROUND OF THE INVENTION

1. Field of the Invention

The invention relates to a technique, specifically a method, apparatus, and article of manufacture that implements the method, to size hardware for software that is driven by events. In particular, the technique determines an event arrival rate and selects a hardware configuration based on benchmarks and the event arrival rate.

2. Description of the Related Art

An enterprise application is a type of computer software that enables a company to programmatically execute business processes. Examples of enterprise applications include, and are not limited to, custom-developed data processing systems, Internet or intranet applications using web technologies, customer relationship management (CRM) software, supply chain management software (SCM), enterprise resource planning (ERP) software, enterprise application integration (EAI) software, and business-to-business (B2B) trading gateways. After a company decides to invest in an enterprise application, the company typically selects server hardware to host the enterprise application.

For example, enterprise resource planning software allows companies to automate the management of business processes across different business functions within the company. Enterprise application integration software enables information to be shared between computer applications and programs by providing the capability of messaging, data mapping, message routing, and business logic processing. Business-to-business trading gateways provide a company with the ability to securely transact with its trading partners at a lower cost than manual processing.

The server hardware that hosts the enterprise application, and in particular, an enterprise application that processes real-time business events, is difficult to size. Because the hardware is typically selected at an early stage of implementation, a very limited amount of information is available for planning. The task of sizing the server hardware for enterprise applications has typically been performed based on experience due to the lack of a methodology that can accommodate large amount of uncertainty. In addition, many enterprise applications are implemented in a phased and modular fashion. The scope tends to expand over time after the company realizes the benefits of the software and also as the company grows. The continuous expansion of scope adds complexity to the hardware sizing effort. Without a scientific way to more accurately select hardware, a company may either overestimate its hardware requirements and invest in more than needed, or underestimate its hardware requirements and purchase hardware that is not sufficiently powerful to handle its requirements. Therefore, there is a need for a method, apparatus and article of manufacture implementing the method, for sizing hardware.

### SUMMARY OF THE INVENTION

To overcome the limitations in the prior art described above, and to overcome other limitations that will become apparent upon reading and understanding the present specification, the present invention discloses a method, apparatus, and article of manufacture for sizing hardware. An event arrival rate is determined. At least one processor system that has a benchmarked event processing rate that is greater than or equal to the event arrival rate is selected. In another aspect of the invention, the size of the memory is also determined.

### BRIEF DESCRIPTION OF THE DRAWINGS

The teachings of the present invention can be readily understood by considering the following detailed description in conjunction with the accompanying drawings, in which:

FIG. 1 depicts an illustrative diagram of an exemplary enterprise application hosted on exemplary server hardware;

FIG. 2 depicts an illustrative computer system that executes an embodiment of the hardware sizing technique using benchmarks;

FIG. 3 depicts a high-level flowchart of an embodiment of the hardware sizing technique of FIG. 2;

FIG. 4 depicts a more-detailed flowchart of an embodiment of the hardware sizing technique of FIG. 3;

FIGS. 5A and 5B collectively depict a more-detailed flowchart of an embodiment of the hardware sizing technique of FIG. 4;

FIG. 6 depicts an embodiment of the format of a business process list used in the embodiment of the hardware sizing technique of FIGS. 5A and 5B;

FIG. 7 depicts an embodiment of the format of a master record list used in the embodiment of the hardware sizing technique of FIGS. 5A and 5B;

FIG. 8 depicts an exemplary master record list using the format of FIG. 7;

FIG. 9 depicts an exemplary business process list using the format of FIG. 6;

FIG. 10 depicts an embodiment of the format of the benchmark information for use with the hardware sizing technique of FIGS. 5A and 5B; and

FIG. 11 depicts exemplary benchmark information in accordance with the format of FIG. 10.

To facilitate understanding, identical reference numerals have been used, where possible, to designate identical elements that are common to some of the figures.

### DETAILED DESCRIPTION OF THE PREFERRED EMBODIMENTS

After considering the following description, those skilled in the art will clearly realize that the teachings of the present invention can be utilized to size hardware for enterprise applications or substantially any other software that is driven by events. In a technique to size the hardware, an event arrival rate is determined. At least one processor system is selected such that a benchmarked event processing rate for the processor system is greater than or equal to the event arrival rate. In another embodiment, a memory size recommendation is also provided.

In yet another embodiment, at a high-level, the technique estimates a burst event arrival rate for the software to compare to event processing rates of the performance benchmarks. The estimate of the burst event arrival rate is derived from an expected annual event volume.

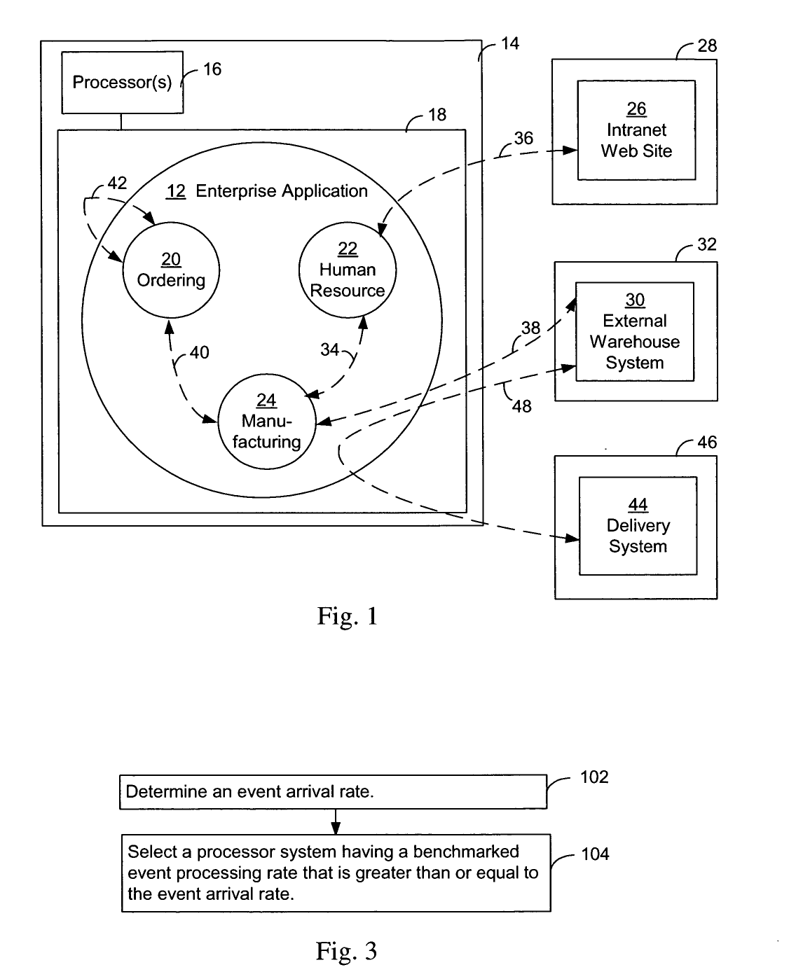

FIG. 1 depicts an illustrative diagram of exemplary enterprise application software 12 that is hosted on server hardware 14. The server hardware 14 has one or more processors 16 to execute the enterprise application 12 which is stored in memory 18 The memory 18 generally comprises different modalities such as random-access memory (RAM) and disk memory.

An enterprise application typically comprises different modules that can be implemented separately and configured differently. For example, enterprise resource planning software may comprise a manufacturing module and a finance module, in addition to other modules. In FIG. 1, the exemplary enterprise application software 12 comprises an ordering module 20, a human resources module 22, and a manufacturing module 24. The exemplary enterprise application 12 also communicates with external enterprise applications such as an Intranet web site 26 hosted on server hardware 28 and an external warehouse system 30 hosted on server hardware 32.

Within an enterprise application, a business process carries out a business function. A business process is initiated by a module of the enterprise application or by an external application (initiating app/module). The business process may be executed by the same module that initiated the business process, by a different module within the enterprise application, or by an external enterprise application (executing app/module).

In FIG. 1, the business processes are represented by dashed lines. For example, FIG. 1 depicts a “work hour entry” business process 34 between the human resources module 22 and the manufacturing module 24, an “employee benefits sign-up” business process 36 from the intranet web site 26 to the human resources module 22, an “order shipment” business process 38 between the manufacturing module 24 and the external warehouse application 30, a “new sales order” business process 40 from the ordering module 20 to the manufacturing module 24, and a “invoice generation” business process 42 entirely within the ordering module 20.

An event is the unit of work of a business process and is associated with a single performance or execution of a business process. Events can be initiated by a human user, an external application, a module, a trading partner or a job scheduler. For example, the types of events include, and are not limited to, a business transaction (for example, a salesman pressed a “submit sales order” button), a task requested by a user (for example, an invoice is generated from the sales order), processing subsequent to the completion of another business process (for example, the invoice is posted to the accounting system after shipment has been delivered), and data to be synchronized to multiple modules or external applications. During runtime, the enterprise application, in particular, the initiating app/module, detects or receives events from the event initiator. The events are executed by the executing app/module which may be the initiating app/module, another module within the enterprise application or an external application.

In another exemplary embodiment, the enterprise application 12 is enterprise application integration (EAI) software which interconnects various external applications including at least one initiating application and at least one executing application. In the case of enterprise application integration software, business processes are typically called interface programs, which allow business functions to be executed across different enterprise applications. Logical groupings of different interface programs are equivalent to the modules of generic enterprise applications. For example, the enterprise application integration software interconnects the external warehouse system with an external delivery system application 44 hosted on server hardware 46 to enable a “delivery tracking” interface program 48. In another more particular exemplary embodiment, the enterprise application integration software is IBM® WebSphere® Business Integration (IBM and WebSphere are registered trademarks of International Business Machines Corporation).

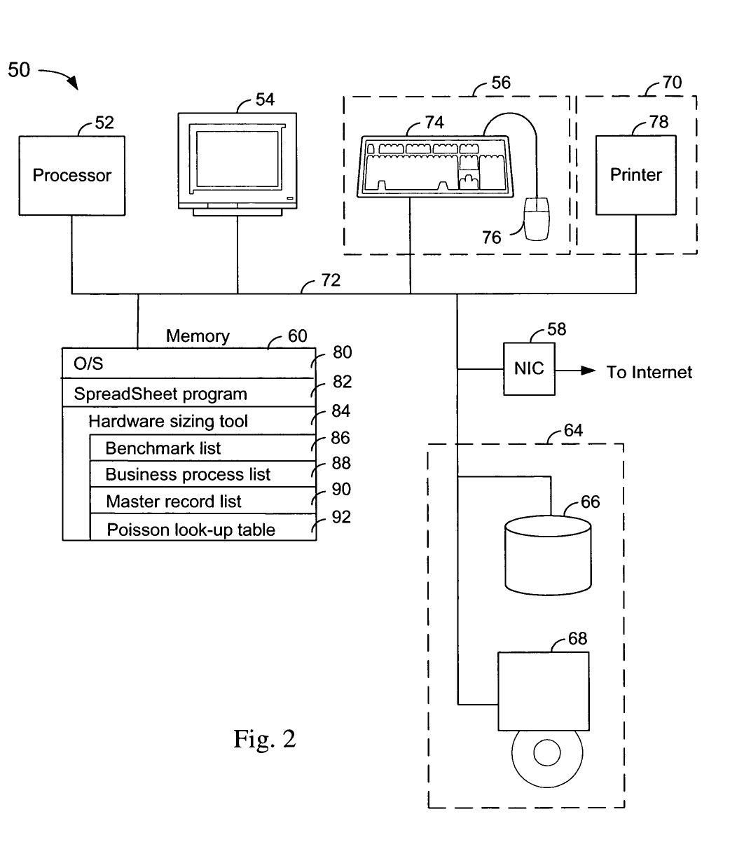

FIG. 2 depicts an illustrative computer system 50 that utilizes the teachings of the present invention. The computer system 50 comprises a processor 52, display 54, input interfaces (I/F) 56, communications interface 58, memory 60, disk memories 64 such as hard disk drive 66 and optical disk drive 68, and output interface(s) 70, all conventionally coupled by one or more busses 72. The input interfaces 56 comprise a keyboard 74 and mouse 76. The output interface is a printer 78. The communications interface 58 is a network interface card (NIC) that allows the computer 50 to communicate via a network, such as the Internet.

The memory 60 generally comprises different modalities, illustratively semiconductor memory, such as random access memory (RAM), and disk drives. The memory 60 stores the software including, but not limited to, operating system (O/S) 80 and application programs such as a spreadsheet program 82 and the hardware sizing tool 84. The O/S 80 may be implemented by any conventional operating system, such as z/OS® (Registered Trademark of International Business Machines Corporation), AIX® (Registered Trademark of International Business Machines Corporation), UNIX® (UNIX is a registered trademark in the United States and other countries licensed exclusively through X/Open Company Limited), LINUX® (Registered Trademark of Linus Torvalds), and WINDOWS® (Registered Trademark of Microsoft Corporation).

Generally, the software is tangibly embodied in a computer-readable medium, for example, memory 60 or, more specifically, one of the disk drives 64, and is comprised of instructions which, when executed by the processor 52, causes the computer system 50 to utilize the present invention. In one embodiment, the memory 60 may store a portion of the software and data in semiconductor memory, while other portions of the software and data are stored in disk memory. In some embodiments, the memory 60 stores the operating system 80, a spreadsheet program 82, a hardware sizing tool 84, a benchmark list 86, a business process list 88, a master record list 90 and a Poisson look-up table 92.

The spreadsheet program is Microsoft® (Registered Trademark of Microsoft Corporation) Excel. Alternately, other spreadsheet programs may be used.

In one embodiment, the hardware sizing tool 84 is implemented in a spreadsheet. The benchmark list 86, business process list 88, master record list 90 and Poisson look-up table 92 are part of the hardware sizing tool spreadsheet. Alternately, the benchmark list 86, business process list 88, master record list 90 and Poisson look-up table 92 are not part of the hardware sizing tool spreadsheet and may be in separate spreadsheets.

In another alternate embodiment, the hardware sizing tool 84 is implemented in a database. In yet another alternate embodiment, the hardware sizing tool 84 is implemented as a computer program.

In a more particular embodiment, the hardware sizing tool receives various inputs including, and not limited to, one or more of the following: the hardware's life expectancy, a partial list of business processes that have been planned to be implemented, event volumes of some planned business processes at the present time, volumes of some master records, an annual growth rate of the business, a total number of potential business processes in addition to those planned, a seasonal effect, a number of operational days in a month, a business operation pattern, a confidence level, and empirical performance benchmarks. The inputs allow the hardware sizing tool to calculate an expected peak per-second event arrival rate for the processor system that will execute the enterprise application. The hardware sizing tool uses a statistical method to approximate a burst per-second event arrival rate from the expected peak per-second event arrival rate and a confidence level. The burst per-second event arrival rate is compared to benchmarks comprising benchmarked event processing rates for various processor systems. The benchmarks are empirical data. A processor system is recommended, followed by a memory size recommendation.

FIG. 3 depicts a high-level flowchart of a technique implemented by the hardware sizing tool 84 of FIG. 2. In step 102, an event arrival rate is determined. In one embodiment, the event arrival rate is a burst per-second event arrival rate. In step 104, a processor system is selected that has a benchmarked event processing rate greater than or equal to the event arrival rate.

The technique for sizing hardware will now be described with respect to enterprise application software. However, the technique may be used to size hardware for other event driven software. In addition, the technique will be described with respect to business processes. However, the technique is not limited to business processes, and may be used to size hardware for substantially any process that has an initiating application or module that generates events, and an executing application or module that processes events.

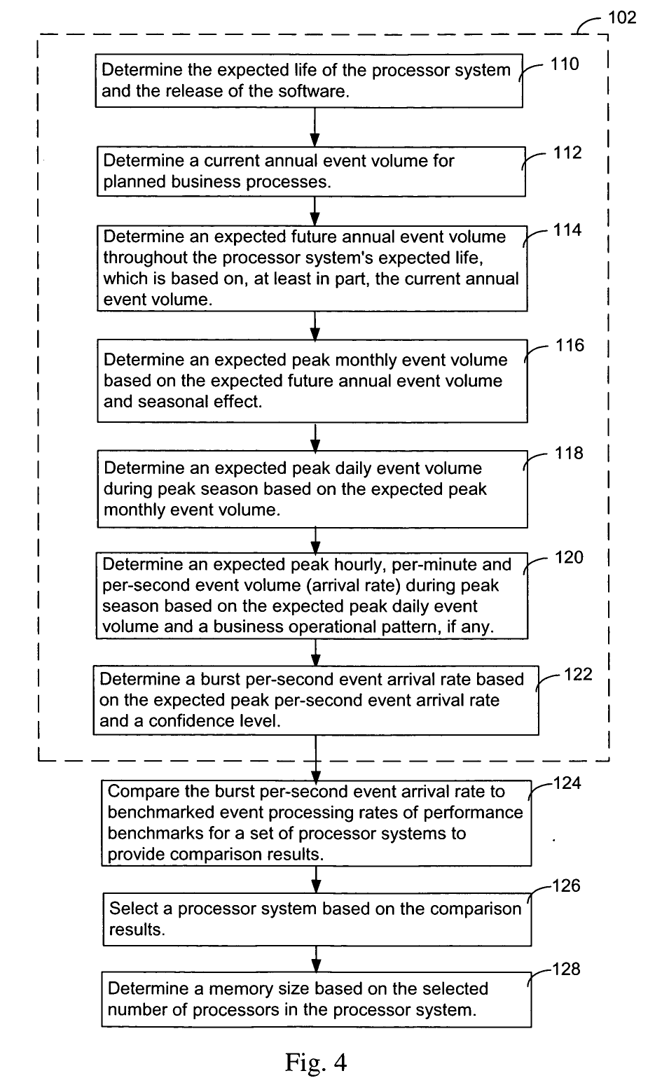

FIG. 4 depicts a more detailed flowchart of the technique of FIG. 3. Steps 110 to 122 correspond to step 102 of FIG. 3. In step 110, the expected life of the processor system and the release number of the software that will be executed on the processor system are determined and input. In step 112, a current annual event volume is determined for planned business processes. In step 114, an expected future annual event volume throughout the processor system's expected life is determined. The expected future annual event volume is based, at least in part, on the current annual event volume. In step 116, an expected peak monthly event volume is determined based the expected future annual event volume and seasonal effect. In step 118, an expected peak daily event volume is determined based on the expected peak monthly event volume. In step 120, an expected peak hourly, per-minute and per-second event volume or arrival rate during peak season is determined based on the expected peak daily event volume and a business operational pattern, if any. In step 122, a burst per-second event arrival rate is determined using Poisson approximation based on the expected peak per-second event arrival rate and a confidence level.

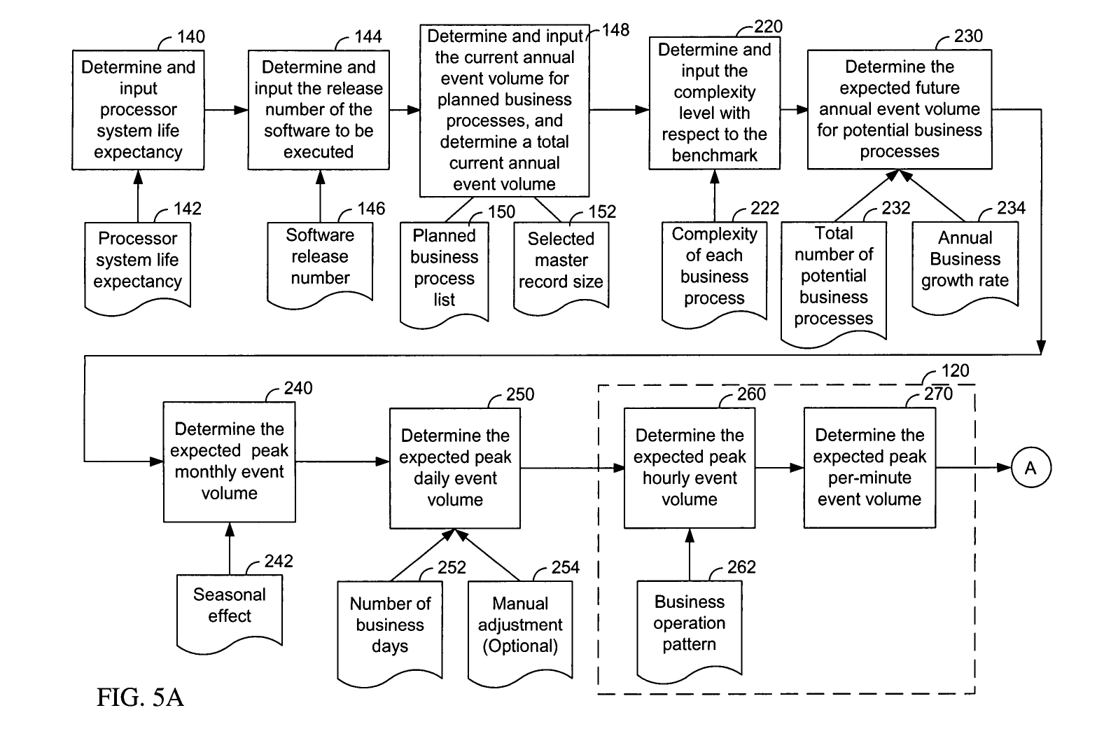

In another embodiment, which will be discussed in further detail with respect to FIGS. 5A and 5B, the burst per-second arrival rate may be adjusted to provide a buffer to help prevent underestimating the burst per-second arrival rate due to inaccurate inputs. In another alternate embodiment, the burst per-second event arrival rate is adjusted in accordance with the complexity of the processing logic of the enterprise application.

In step 124, the burst per-second event arrival rate is compared to performance benchmarks for a set of processor systems to provide comparison results. The performance benchmarks comprise benchmark event processing rates for each processor system. In step 126, a processor system is selected based on the comparison results. The benchmark event processing rate of the selected processor system is greater than or equal to the burst per-second event arrival rate. In an alternate embodiment steps 124 and 126 are combined in a single step to select at least one processor system. In step 128, the size of the memory, such as random access memory (RAM) is determined based on the number of processors in the processor system.

FIGS. 5A and 5B collectively depict a more-detailed flowchart of the technique for sizing hardware of FIG. 4. Steps 140 and 144 correspond to step 110 of FIG. 4. In step 140, the expected life of the processor system 142 is determined and input to the hardware sizing tool. The processor system will be selected to provide sufficient capacity to handle the event volume at its burst arrival rate without an upgrade in major resources for a specified number of years. For example, an upgrade in major resources includes, and is not limited to, adding additional processors. The processor system life expectancy will be referred to as y.

In step 144, the release number 146 of the software, for example, the enterprise application, is determined and input to the hardware sizing tool. The release number allows a person performing sizing to take advantage of the different configurations of the enterprise application. For various releases of the enterprise application, the same benchmark is run to provide a comparison of the performance of various processor systems.

In step 148, a current annual event volume for the planned business processes is estimated and input. Step 148 corresponds to step 112 of FIG. 4. Information about the planned business processes that will be implemented on the processor system is collected. The person who performs the hardware sizing collects the annual event volume at the present time for as many planned business processes as possible, especially for mission critical business processes such as Sales or Purchase Order processing.

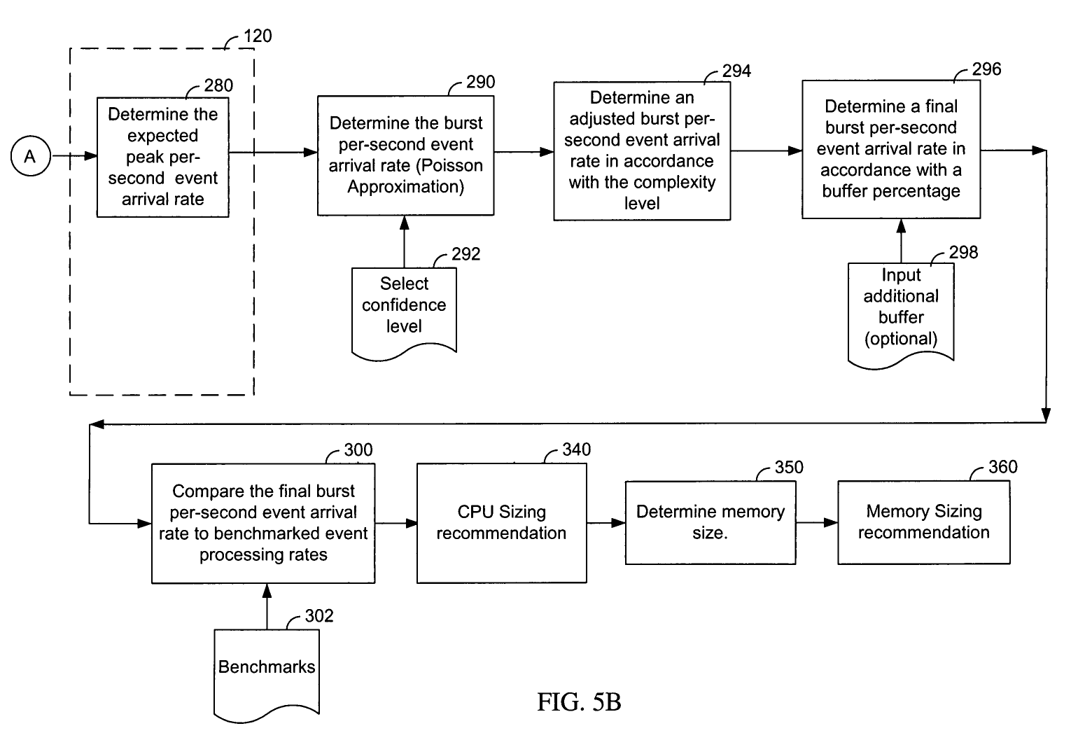

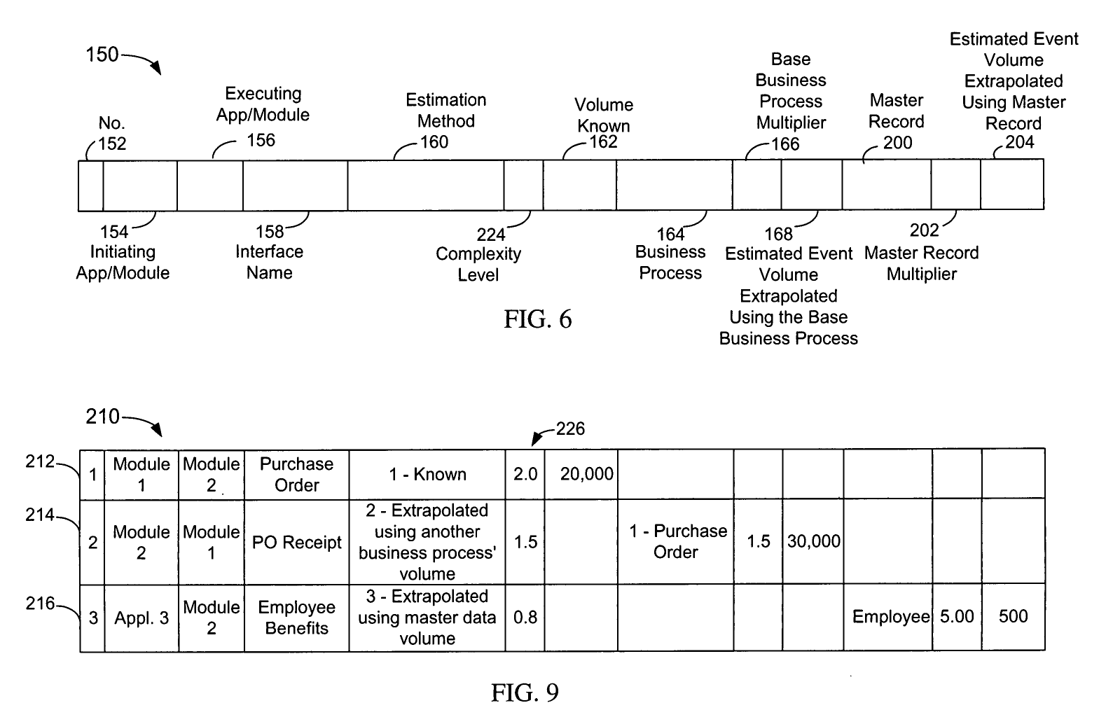

Referring also to FIG. 6, a business process list 150 is used to collect and determine the current annual event volumes for the planned business processes. FIG. 6 depicts an embodiment of the format of a business process list 150. In one embodiment, the business process list 150 is part of a spreadsheet implementing the hardware sizing tool. The business process list 150 has a business process number 152, an initiating application or module (Initiating App/Module) name field 154 to store the name of the enterprise application's module or an external application which initiates the event, an executing application or module (Executing App/Module) name field 156 to store the name of the enterprise application's module or an external application where the event will be processed or transported to, and a business process name field 158. The remaining fields will be described below. For each business process, the business process number, initiating app/module name and executing app/module name as well as a descriptive name are entered.

The current annual event volume for each planned business process is determined and input to the business process list. The current annual event volume may be determined in several ways. The current annual event volume may be an actual volume that is known or can be directly projected. The actual annual event volumes are collected for as many planned business processes as possible. For those planned business processes for which the actual event volumes are known, “1—Known” is entered into the estimation method field 160 of the business process list 150, and the actual annual volume for that business process is entered into a volume known field 162 of the business process list 150.

Alternately, if the actual annual event volume cannot be collected for a planned business process, the current annual event volume may be estimated. In one embodiment, shown in FIG. 6, the business process list is used to estimate the volumes. In a first embodiment, the current annual event volume for a business process is extrapolated from the actual event volume of another business process, referred to as the base business process. For example, in a manufacturing company, the volumes of most transaction-related processes are functions of either the volume of sales orders or purchase orders. Assume that the number of sales orders per year has been provided. Because customer invoices are generated from sales orders, the volume of sales orders can be used to extrapolate the volume of customer invoices. In addition, a base business process multiplier can be applied to the known volume of the base business process to extrapolate the volume of the business process of interest. For example, on the average, if one sales order generates three delivery orders, then the number of sales orders would be multiplied by three to estimate the number of delivery orders.

In FIG. 6, the estimation method field 160 is populated with “2—Extrapolated using another business process' volume”. A base business process field 164 stores the number and name of the base business process, and a base business process multiplier field 166 stores the base business process multiplier. An “Estimated Event Volume Extrapolated Using the Base Business Process” field 168 contains the product of the actual event volumes from the base business process and the base business process multiplier.

In second embodiment, a business process' current annual event volume is estimated from the number of records in a master record database. For example, a master record database may comprise any of item, customer, vendor, or employee records. The item records may be a list of products. The current annual event volume of many business processes that synchronize non-transactional data can be extrapolated using the number of records in one of the master record databases. For example, to estimate the volume of a business process that synchronizes item data between a manufacturing application and a supply chain management application, the number of records in the item master database and a multiplier are used. Many companies can provide the number of records stored in their item master database and a multiplier, that is, the average number of events each item record generates each year for the business process of interest.

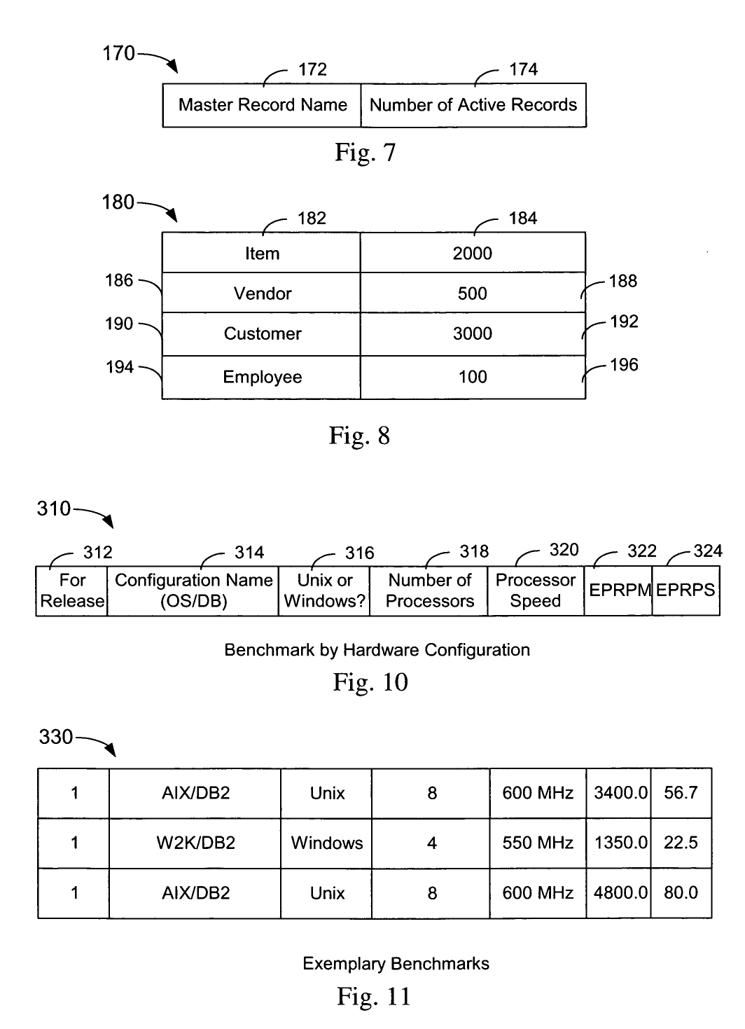

Referring also to FIG. 7, a list of master records having the master record format 170 is updated to associate the name of the master record database in a master record name field 172 with the number of active records for that master record database in a number of active records field 174. In one embodiment, the master record list is part of the spreadsheet implementing the hardware sizing tool.

In FIG. 8, an exemplary master record list 180 is shown. The list of master records may contain information about different master record databases. An Item master record database 182 has 2,000 records 184, a vendor master record database 186 has 500 records 188, a customer master record database 190 has 3,000 records 192, and an employee master record database 194 has 100 records 196.

Referring back to FIG. 6, the business process list 150 is updated. The term, “3—Extrapolated using master data volume,” is entered into the estimation method field 160. A master record field 200 is populated with the name of the master record database from the master record list, and a master record multiplier 202 is populated with the value of the master record multiplier for that business process. An “Estimated Event Volume Extrapolated Using Master Record” field 204 stores the product of the number of master records and the master record multiplier to provide an estimated event volume for that business process.

For instance, the number of times that a record is updated per year may be used as the multiplier. The current annual event volume of a business process that synchronizes item information may be estimated from the number of item records in the item master record database. If an item record is updated three times per year, and there are 2,000 item records, then 6,000 events will be generated annually.

FIG. 9 depicts an exemplary worksheet 210 to estimate the current annual event volume using the format of FIG. 6. In summary, the estimation method field stores the type of method used to determine the current annual event volume. As described above, the current annual event volume may be (1) known, (2) extrapolated using another business process' volume, or (3) extrapolated using the volume of a master record database. The first business process, Purchase order, 212, has an initiating app/module of “Module 1” and an executing app/module of “Module 2”. The estimation method is “1—Known”, meaning that the volume is either given or directly projected, and the volume is equal to 20,000 events per year. The second business process 214, PO Receipt, has an initiating app/module of “Module 2” and an executing app/module of “Module 1”. The estimation method is “2—Extrapolated using another business process' volume,” the base business process is “1—Purchase Order”, and the base business process multiplier is equal to 1.5. The current annual event volume of the Purchase Order (PO) Receipts can be extrapolated from the number of Purchase Orders based on an assumption that each Purchase Order generates 1.5 Purchase Order Receipts per year. Thus, the estimated current annual event volume is equal to 30,000. The third business process, Employee Benefits, 216, has an initiating app/module of external “Application 3” (Appl. 3), and an executing app/module of “Module 2”. The estimation method is “3—Extrapolated using master data volume.” The master record name is “Employee” and the master record multiplier has a value of 5.00. The current annual event volume of Employee Benefits can be extrapolated using the number of Employee master records based on an assumption that each Employee master record generates five Employee Benefits events. Therefore, the estimated current annual event volume, 500, is equal to the product of the number of records of Employee from the master record list (100) and the master record multiplier (5.00).

Although three techniques for determining the current annual event volume have been described, the invention is not meant to be limited to these three techniques and may be used with other techniques for determining event volumes.

The hardware sizing tool determines the current annual event volume for each planned business process as described above using the business process list. The number of planned business processes is represented by n. The current annual event volume for each of the n individual planned business processes is represented by Vp₁, Vp₂, . . . , Vpₙ. The hardware sizing tool determines a total current annual event volume Vp for all planned business processes at the present time as follows:

$$Vp = {\sum }_{i = 1}^{n} {Vp}_{i}$$

Referring back to FIG. 5A, in step 220, a complexity level 222 is determined and input to the hardware sizing tool. Referring also to FIG. 6, a complexity level field 224 is provided for each business process in the business process list 150. The complexity level of each planned business process is assigned relative to the benchmarked business process. If the performance benchmark was designed to perform certain functions, then the complexity level of each planned business process will be evaluated with respect to those specific functions. For a planned business process with a complexity identical to that of the benchmarked business process, the complexity level is equal to one. For example, in one embodiment, the complexity level is determined with considerations that include, and are not limited to, factors such as the event size, the number of database accesses, the difficulty of data transformation, and the complexity of the business logic. However, factors relating to the server hardware such as processor speed and the hard disk access latency are not considered in determining the complexity level. For the n planned business processes, the complexity level for each business process is represented as C₁, C₂ . . . Cₙ with a basis of one. The complexity level will be applied later to the volume estimates of the business processes. In an alternate embodiment, no complexity level is assigned.

For example, a create-customer-record business process creates customer records in a database of a customer relationship management system in response to an intranet web page. The create-customer-record business process has been benchmarked, and is selected as the basis. A business process with identical complexity would have a complexity level of one. Each of the business processes on the business process list 150 is assigned a complexity level relative to the benchmarked create-customer-record business process. In an alternate embodiment, another benchmarked business process may be selected as the basis.

Different methods may be used to estimate the complexity level relative to a benchmarked business process. In a first method, the complexity level is estimated from the measured processing time. Generally throughput increases when the processing time decreases, and throughput decreases when the processing time increases. The complexity level can be determined as follows. First, the end-to-end processing time of a selected benchmarked business process is measured on any computer hardware. Second, the end-to-end processing time of the business process of interest is measured on the same computer hardware. Third, the complexity level is calculated by dividing the processing time of the business process of interest by the processing time of the selected benchmarked business process.

In a second method, the complexity level is estimated based on experience. The person who performs sizing studies the benchmarked business process and each of the business processes on the business process list 150. The person who performs sizing then assigns a complexity level based on his or her own experience with respect to the potential processing time once the planned business process is implemented. For example, the person who performs sizing may expect a particular business process to take twice the time to process than the benchmarked business process on the same server hardware because of certain complex data transformation logic, therefore he or she assigns a complexity level equal to 2.0 to the business process of interest. In FIG. 9, the complexity level field 226 is populated for each of the three exemplary business processes.

In step 230, the hardware sizing tool determines the expected future annual event volume throughout the processor system's expected life, y years. Step 230 is an embodiment of step 114 of FIG. 4. The total number of business processes 232 that the processor system is expected to ever host, m, is estimated and input to the hardware sizing tool. Step 230 attempts to include business processes that have not been planned or named. The number of all business processes, both unplanned and planned, is referred to as m. In other words, the number of all business processes m includes the number of planned business processes n plus an allowance for a number of unplanned business processes.

The event volume is also adjusted for any growth in the business. Event volumes increase as a company grows. The year-over-year revenue growth rate for a company over the past few years can be used as the business growth rate to project the future. For a publicly traded company, the year-over-year revenue growth can be obtained by examining the annual reports (Form 10-K). The expected year-over-year growth rate is represented by g %. The business growth rate is input to the hardware sizing tool.

The hardware sizing tool determines the expected future annual event volume for all business processes throughout the processor system's expected life, V_{year}, as follows:

$${V}_{year} = Vp \times \frac{m}{n} \times {( 1 + g \% )}^{y}$$

In step 240, the hardware sizing tool determines the expected peak monthly event volume Vₘₒₙₜₕ. Step 240 of FIG. 5A corresponds to step 116 of FIG. 4. A seasonal effect 242, if any, is identified and input to the hardware sizing tool. The seasonal effect rₘₒₙₜₕ% is represented as the percentage of business activities in the peak month over the entire year. For example, December is typically the busiest month for retailers and the percentage of sales in December could represent over 15% of the entire year's revenue. Typically a business analyst can provide the percentage of business activities in the peak month. If not available, industry averages from the U.S. Census Bureau may be used. The hardware sizing tool determines the expected peak monthly event volume, Vₘₒₙₜₕ, as follows:
Vₘₒₙₜₕ=V_{year}×rₘₒₙₜₕ%
In an alternate embodiment, the seasonal effect is not applied and Vₘₒₙₜₕ can be calculated by dividing the expected future annual event volume, V_{year}, by twelve.

In step 250, the hardware sizing tool determines the expected peak daily event volume during the busiest month of the year. Step 250 of FIG. 5A corresponds to step 118 of FIG. 4. The number of operational business days 252 in the peak month n_{businessdays} is determined and input to the hardware sizing tool. In some embodiments, an optional adjustment factor rₒₚₜᵢₒₙₐₗ% 254 may be input to the hardware sizing tool. If a company has a business pattern such that a specific day in the busiest month frequently has more business activities than any other day in the month, then an adjustment factor may be applied. For example, the busiest month for most retailers is December. If the Sunday before Christmas always has heavier sales activity than any other day of December, and the system may be presented with 20% more events on that particular day than other days in December, then the 20% may be input as an adjustment factor and applied. The expected peak daily event volume V_{day} is determined as follows:
V_{day}=(Vₘₒₙₜₕ÷n_{businessdays})×(1+rₒₚₜᵢₒₙₐₗ%).

Next, the expected peak hourly, per-minute and per-second event volumes during the peak day of the busiest month are determined based on a business operational pattern in a day. Steps 260-280 correspond to step 120 of FIG. 4. Business events not only occur primarily during business hours but may also be heavily concentrated in mid-morning and mid-afternoon. Typically, the largest volume of business events occurs in mid-morning. In particular, typically 15%-20% of an entire day's activities occur between 10:00 AM and 11:00 AM. However, if a company operates from multiple time zones of the United States or the world, the percentage of business activities during the peak hour over the entire day may not exhibit much variation. For example, many companies operating in a single time-zone experience that approximately 20% of the entire day's events occur in the busiest hour of a day, other companies operating in multiple time-zones of the United States experience that approximately 15% of the entire day's events occur in the busiest hour of a day, and yet other companies operating worldwide experience that approximately 10% of the entire day's events occur in the busiest hour of a day. The percentage of business activities in the busiest hour in a day over the entire day is rₕₒᵤᵣ% 262 and is input to the hardware sizing tool. The hardware sizing tool determines the expected peak hourly event volume Vₕₒᵤᵣ during peak season as follows:
Vₕₒᵤᵣ=V_{day}×rₕₒᵤᵣ%.

In step 270, the hardware sizing tool determines the expected peak per-minute event volume. In one embodiment, events are assumed to occur randomly throughout the minutes in an hour. The hardware sizing tool determines the expected event volume per minute, Vₘᵢₙᵤₜₑ, as follows:
Vₘᵢₙᵤₜₑ=Vₕₒᵤᵣ÷60.

In step 280, the hardware sizing tool determines the expected peak per-second event volume, also referred to as an expected peak per-second event arrival rate. In one embodiment, events are assumed to occur randomly throughout the seconds in a minute. The hardware sizing tool determines the expected per-second event arrival rate, V_{second}, as follows:
V_{second}=Vₘᵢₙᵤₜₑ÷60.

Step 290 of FIG. 5A corresponds to step 122 of FIG. 4. In step 290, the hardware sizing tool determines the burst per-second event arrival rate. In one embodiment, the burst per-second event arrival rate is determined using the Poisson approximation.

Since events are assumed to occur randomly, the expected peak per-second event arrival rate is an average. In practice, the number of events that occur during consecutive one second intervals may differ. The hardware sizing tool uses a statistical technique called the “Poisson Approximation” to analyze event occurrence and the associated probability. The burst per-second event arrival rate, V_{burstsec}, at confidence level p % is determined as follows:

$$p \% = {\sum }_{k = 0}^{{V}_{burstsec}} \frac{{ⅇ}^{- {V}_{second}} \cdot {V}_{second}^{k}}{k !} .$$

The burst per-second event arrival rate, V_{burstsec}, represents the number of events that are expected to occur in a second based on p % confidence level. Using two input parameters, the confidence level p % 292 and the expected peak per-second event arrival rate, V_{second}, that was determined in step 280, the burst per-second event arrival rate, V_{burstsec}, can be calculated. The result is interpreted as follows: assuming that the expected peak per-second arrival rate is equal to V_{second}, if the system can handle V_{burstsec} events per second, then p % of the time events will be processed without queuing. In another embodiment, the Poisson look-up table 92 (FIG. 2) is used to determine the burst per-second event arrival rate at a confidence level of p %. For each expected peak per-second event arrival rate of a set of expected peak per-second event arrival rates, the look-up table has a set of burst per-second event arrival rates for a range of confidence levels. Therefore, based on the expected peak per-second event arrival rate and the desired confidence level, the burst per-second event arrival rate can be determined.

In step 294, before the burst per-second event arrival rate, V_{burstsec}, that was determined in step 290, is compared to empirical performance benchmarks, differences in complexity between the planned business processes and the benchmarked business process are reconciled. An overall complexity level C is determined as follows:

$$C = \frac{{\sum }_{i = 1}^{n} ( {Vp}_{i} \cdot {C}_{i} )}{{\sum }_{i = 1}^{n} {Vp}_{i}} .$$

The hardware sizing tool determines an adjusted burst per-second event arrival rate V_{adj} based on the overall complexity level as follows:
V_{adj}=V_{burstsec}×C.
In an alternate embodiment, the burst per-second event arrival rate is not adjusted based on the complexity.

In step 296, the hardware sizing tool determines a final burst per-second event arrival rate, V_{final}, representing the number of events that the system will handle in each second by applying an additional buffer to the adjusted burst per-second event arrival rate, V_{adj}. To accommodate the quality of data input throughout the previous steps, an additional buffer percentage r_{buffer}% 298 can be input to the hardware sizing tool and applied to the adjusted rate, V_{adj}, to produce the final burst per-second arrival rate, V_{final}. The hardware sizing tool determines the final burst per-second event arrival rate, V_{final}, as follows:
V_{final}=V_{adj}×r_{buffer}%

In an alternate embodiment, the hardware sizing tool does not apply the additional buffer and the adjusted burst per-second event arrival rate becomes the final burst per-second event arrival rate V_{final}.

In step 300, the hardware sizing tool compares the final burst per-second event arrival rate, V_{final}, to the event processing rates of the performance benchmarks 302 to provide a comparison result that is used to determine the size of the processor system. Step 300 corresponds to step 124 of FIG. 4. The performance benchmarks are empirical data. The comparison result is whether a particular processor system has an event processing rate that is greater than or equal to the final burst per-second event arrival rate, V_{final}. One or more processor systems that have a benchmarked event processing rate greater than or equal to the final burst per-second event arrival rate, V_{final}, are selected.

Referring also to FIG. 10, an exemplary format 310 of the benchmark list is shown. In one embodiment, the benchmark list contains a release field 312, a configuration name field 314, an operating system type field 316, a number of processors field 318, a processor speed field 320, a benchmarked event processing rate per-minute field (EPRPM) 322, and a benchmarked event processing rate per-second field (EPRPS) 324.

FIG. 11 depicts an exemplary benchmark list 330 having the format of FIG. 10. For example, the first benchmark is for release 1 of an enterprise application, the configuration is for an AIX® operating system and DB2® database management system, and an operating system type of Unix®. The number of processors is equal to eight, the processor speed is equal to 600 Megahertz (MHz), the benchmarked event processing rate per-minute (EPRPM) is equal to 3,400 events per minute, and the benchmarked event processing rate per-second (EPRPS) is equal to 56.7 events per second.

The hardware sizing tool determines that a processor system will meet the performance requirements by selecting the processor system having a benchmarked per-second event processing rate, equal to, or closest to and exceeding the final burst per-second event arrival rate as the processor system sizing recommendation 340. Alternately, the hardware sizing tool selects multiple processor systems that have a benchmarked per-second event processing rate exceeding the final burst per-second event arrival rate as the processor system sizing recommendation 340. The processor system sizing recommendation is displayed.

Step 350 of FIG. 5B corresponds to step 128 of FIG. 4. In step 350, in an alternate embodiment, the hardware sizing tool determines a recommended size of the memory 360, more particularly, random-access memory (RAM), as follows:

$$\begin{matrix}RAM size = 2 Gigabytes ( GB ) , when the processor system has \\ 1 processor , \\ = 4 GB , when the processor system has 2 processors , \\ and \\ = ( 4 + u - 2 ) GB , when the processor system has u \\ processors and u > 2.\end{matrix}$$

Alternately, other techniques can be employed to determine the memory size based on the number of processors.

The present invention provides a framework for users to make a scientific estimate of the event volume and arrival rate for software to size host hardware based on limited information. By breaking down the uncertainties in each step, the uncertainties can be quantified and justified.

The invention has been described by way of specific embodiments relating, for example, to enterprise applications. Those skilled in the art will understand that this invention may have broader applicability to other software applications, programs or environments and various changes in form and detail may be made without deviating from the spirit or scope of the invention.

1. A method of sizing hardware, comprising:
determining a system event arrival rate; and
selecting a processor system having a benchmark event processing rate that is greater than or equal to the system event arrival rate.

2. The method of claim 1 wherein the system event arrival rate is a burst event arrival rate.

3. The method of claim 1 further comprising:
determining an amount of memory in accordance with a number of processors in the selected processor system.

4. The method of claim 1 wherein said determining the system event arrival rate comprises:
determining an annual event volume for each planned business process, wherein the system event arrival rate is based, at least in part, on the annual event volume for each planned business process.

5. The method of claim 4 wherein said determining comprises:
extrapolating an event volume for one or more planned business processes from another planned business process' volume to provide an extrapolated event volume, wherein the system event arrival rate is based, at least in part, on the extrapolated event volume.

6. The method of claim 4 wherein said determining comprises:
extrapolating the event volume for one or more planned business processes from a master record volume to provide an extrapolated event volume, wherein the system event arrival rate is based, at least in part, on the extrapolated event volume.

7. The method of claim 1 wherein said determining comprises:
selecting a confidence level that events will not be queued and determining the system event arrival rate in accordance with the confidence level.

8. An apparatus for sizing hardware, comprising:
a computer having a storage device connected thereto; and
one or more computer programs, stored on the storage device, and to be executed by the computer, for:
determining a system event arrival rate; and
selecting a processor system having a benchmarked event processing rate that is greater than or equal to the system event arrival rate.

9. The apparatus of claim 8 wherein the system event arrival rate is a burst event arrival rate.

10. The apparatus of claim 8 wherein said one or more computer programs is also for:
determining an amount of memory in accordance with a number of processors in the selected processor system.

11. The apparatus of claim 8 wherein said determining the system event arrival rate comprises:
determining an annual event volume for each planned business process, wherein the system event arrival rate is based, at least in part, on the annual event volume for each planned business process.

12. The apparatus of claim 8 wherein said determining comprises:
extrapolating an event volume for one or more planned business processes from another planned business process' volume or a master record volume to provide an extrapolated event volume, wherein the system event arrival rate is based, at least in part, on the extrapolated event volume.

13. The apparatus of claim 8 wherein said determining comprises:
selecting a confidence level that events will not be queued and determining the system event arrival rate in accordance with the confidence level.

14. An article of manufacture comprising a computer program carrier readable by a computer and embodying one or more instructions executable by the computer to perform a method of sizing hardware, the method comprising:
determining a system event arrival rate; and
selecting a processor system having a benchmark event processing rate that is greater than or equal to the system event arrival rate.

15. The article of manufacture of claim 14 wherein the system event arrival rate is a burst event arrival rate.

16. The article of manufacture of claim 14 wherein the method further comprises:
determining an amount of memory in accordance with a number of processors in the selected processor system.

17. The article of manufacture of claim 14 wherein said determining the system event arrival rate comprises:
determining an annual event volume for each planned business process, wherein the system event arrival rate is based, at least in part, on the annual event volume for each planned business process.

18. The article of manufacture of claim 14 wherein said determining comprises:
extrapolating an event volume for one or more planned business processes from another planned business process' volume to provide an extrapolated event volume, wherein the system event arrival rate is based, at least in part, on the extrapolated event volume.

19. The article of manufacture of claim 14 wherein said determining comprises:
extrapolating the event volume for one or more planned business processes from a master record volume to provide an extrapolated event volume, wherein the system event arrival rate is based, at least in part, on the extrapolated event volume.

20. The article of manufacture of claim 14, wherein said determining comprises:
selecting a confidence level that events will not be queued and determining the system event arrival rate in accordance with the confidence level.
